(19) United States
(12) Patent Application Publication
(10) Pub. No.: US 2005/0132367 A1
(43) Pub. Date: Jun. 16, 2005

(54) Method, apparatus and system for proxying, aggregating and optimizing virtual machine information for network-based management

(76) Inventors: Vijay Tewari, Portland, OR (US); Scott H. Robinson, Portland, OR (US); Robert C. Knauerhase, Portland, OR (US)

Correspondence Address: INTEL CORPORATION, P.O. BOX 5326, SANTA CLARA, CA, 95056-5326, US

(21) Appl. No.: 10/738,839

(22) Filed: Dec. 16, 2003

(51) Int. Cl. G06F 9/455

(52) U.S. Cl. 718/1

(57) ABSTRACT

A method, apparatus and system enable a management virtual machine to act as a proxy for other virtual machines on a virtual machines host. In one embodiment, the management virtual machine may maintain a database of network management information pertaining to each virtual machine on the host. An enhanced virtual machine manager on the host may provide an interface to the management virtual machine to enable the management virtual machine to trap management messages destined for virtual machines on the host. The management virtual machine may respond to the messages based on information in the database and/or issue queries to the virtual machines to obtain the requisite information. In one embodiment, the management virtual machine may aggregate the information from various virtual machines prior to responding to the network management message.

### FIELD

The present invention relates to the field of network-based resource management, and, more particularly to a method, apparatus and system for proxying, aggregating and optimizing virtual machine information for network-based management.

### BACKGROUND

As corporations grow and technology advances, the task of managing corporate networks is becoming increasingly difficult. More specifically, various aspects of network and system management, such as network architecture and evolution, as well as resource management, have become increasingly complex. As a result, there is a significant trend of consolidating servers to reduce management complexity and cost, power consumption and general network maintenance.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIG. 2 illustrates a typical remote network-based management console on a network including virtual machine hosts;

FIG. 3 illustrates an overview of an embodiment of the present invention; and

FIG. 4 is a flowchart illustrating an embodiment of the present invention.

### DETAILED DESCRIPTION

Embodiments of the present invention provide a method, apparatus and system for proxying, aggregating and optimizing virtual machine resource information for network-based management. The term “network-based management” as used herein shall include management of various types of network resources (i.e., resources such as routers that comprise the network, as well as resources connected to the network, such as cellular telephones, handhelds, personal data assistants (PDA's), laptop computers, desktop computers, workstations, servers, mainframes, etc. and the software running on these devices (e.g. operating systems and applications)). Additionally, reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

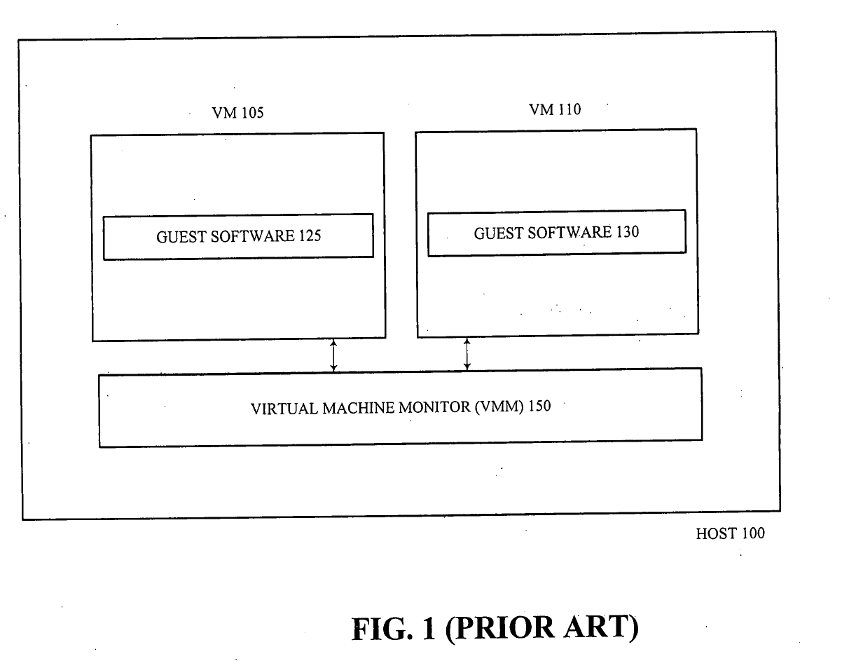

Virtualization technology enables corporations to consolidate servers by providing secure, isolated partitions on a single host. FIG. 1 illustrates an example of a typical virtual machine host device (“Device 100”). As illustrated, a virtual-machine monitor (“VMM 150”) typically runs on the device and presents an abstraction(s) of the device platform (also referred to as “virtual machines”) to other software. It is well-known to those of ordinary skill in the art that VMM 150 may also be referred to as a “hypervisor”. Although only two virtual machine partitions are illustrated (“VM 105” and “VM 110”, hereafter referred to collectively as “Virtual Machines”), these Virtual Machines are merely illustrative and additional virtual machines may be added to the host. VMM 150 may be implemented in software, hardware, firmware and/or any combination thereof (e.g., a VMM hosted by an operating system).

VM 105 and VM 110 may function as self-contained platforms respectively, running their own “guest operating systems” (i.e., operating systems hosted by VMM 150) and other software (the guest operating system and other software illustrated conceptually as “Guest Software 125” and “Guest Software 130”, hereafter referred to collectively as “Guest Software”). Each Guest Software operates as if it were running on a dedicated computer rather than a virtual machine. That is, each Guest Software may expect to control various events and have access to hardware resources. In reality, VMM 150 has ultimate control over the events and hardware resources and allocates resources to Guest Software as necessary.

Each Virtual Machine may also include multiple levels or “recursions” of virtual machines. In other words, each Virtual Machine may itself run a “guest VMM” (i.e., a VMM hosted by VMM 150) and other software. Thus, for example, VM 105 may host another VMM with its own set of virtual machines, while VM 110 may host an operating system. It will be readily apparent to those of ordinary skill in the art that multiple recursions of virtual machines and VMM's may be employed in arbitrary configurations.

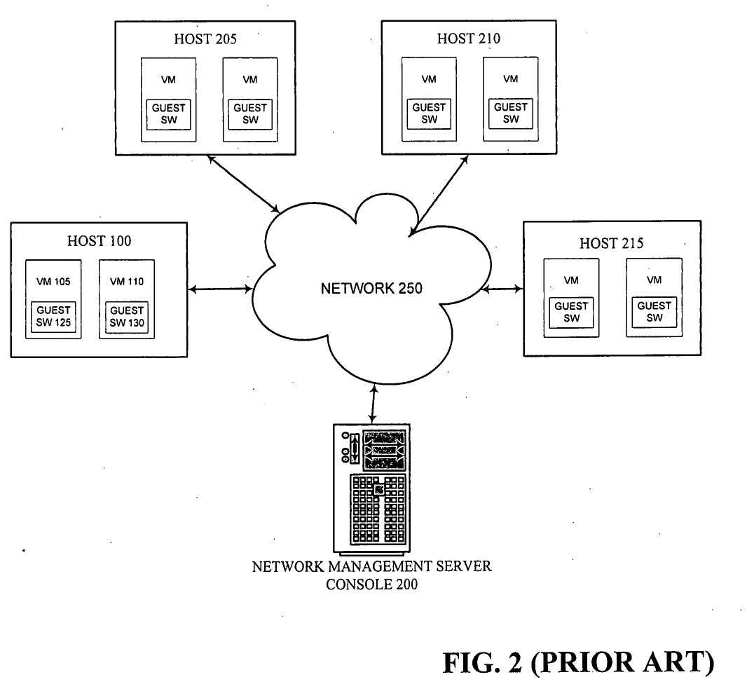

Various types of network-based management software exist currently to monitor and manage network resources. FIG. 2 illustrates a typical network (“Network 250”) including a network-based management console (“Network Management Server Console 200”) capable of generating network management messages, a host data processing device (“Device 100”) and multiple virtual machines (e.g., VM 105 and VM 110) hosted by Device 100. Device 100 may be connected via network 250 to multiple other physical hosts (illustrated as “Device 205”, “Device 210” and “Device 215”). Currently available network-based management software treats each virtual machine on the network as an independent entity (oftentimes, as a separate host). Thus, to Network Management Server Console 200, if the network includes M number of host devices, each running N number of virtual machines, the console may see the network as consisting of M*N number of separate entities. It is apparent to those of ordinary skill in the art that managing networks having M*N number of virtual entities is exceedingly complex and may result in significant inefficiencies. For example, multiple network management messages may be sent to and from a single host device, i.e., one for each of the Virtual Machines running on Device 100. Network management messages include, but are not limited to, Simple Network Management Protocol (“SNMP”) messages, Web-Based Enterprise Management (“WBEM”) messages, Intelligent Platform Management Interface (“IPMI”) messages, Common Information Model (“CIM”) messages, and other distributed management protocol messages.

In some cases the information contained in the network messages may be duplicated/common to each VM and/or known to the VMM, e.g., determining platform system time or geographic location or determining how much memory is available to each Virtual Machine. In other cases, the network management messages may be seemingly irrelevant or unavailable in the virtual machine environment, but relevant to the network-based management software (e.g., a query regarding the temperature of the Virtual Machines). Some information in the virtual machine may be untrustworthy because the VMM may or may not virtualize various elements of the platform. Thus, for example, if queried about temperature of the CPU, each Virtual Machine on Device 100 may respond with the same information, i.e., the temperature of Device 100, or alternatively, none of the Virtual Machines may respond because the information is irrelevant or unavailable in the virtual machine environment. For example, Device 100 may be configured to provide no temperature information to the Virtual Machines for security purposes, or alternatively, the VMM may provide the Virtual Machines with information about emulated devices. In order to properly perform its network management functions, however, network-based management software requires accurate information about the state of the network. Thus, for example, if there were a recall on a hardware element of a real hardware device, the network-based management software may need to know what physical versions of that hardware exist on the network(i.e., not just information about a software emulated version, as software emulated versions may be immune to such a hardware component failure). Conversely, it may be necessary to identify both physical and virtual devices for provisioning a licensed software driver.

When a network management message is sent, in order to respond, each Virtual Machine has to be context switched “in”. More specifically, when Device 100 receives a message directed to a guest software on a particular VM, the respective VM must become the active VM to respond, i.e., state information associated with the VM is retrieved from memory and/or disk in order to execute the VM. This process may continue repeatedly for each management-enabled VM on Device 100. Context switches are expensive and may degrade system performance, especially if large numbers of Virtual Machines and/or messages need to be managed. Since the Virtual Machines on Device 100 may be in various states (e.g., idle, hibernation, etc.), certain context switches may require significant time and effort to return to a running and/or executing state. As a result, Virtual Machines may be maintained in idle and/or state of suspension to avoid costly context switches and other restoration overhead (e.g. decompressing a hibernation save image).

According to an embodiment of the present invention, a dedicated virtual machine (hereafter “management virtual machine”) may act as a proxy to all or some subset of virtual machines on a host device. The management virtual machine on the host device may aggregate and/or optimize virtual machine network resource information in response to messages from network-based management software. Embodiments of the present invention may be practiced within various virtual machine environments, e.g., including hardware implementations from Intel Corporation, software environments such as VMWare from VMWare Corporation, Virtual PC/Virtual Server from Microsoft Corporation and/or other emerging virtualization environments such as “VServer” (Version 0.28, December 2003), “Denali” (2002, Department of Computer Science and Engineering, The University of Washington”), “XEN” (2003, Computer Laboratory, University of Cambridge), which are currently under development.

In one embodiment, the management virtual machine is “VMM aware” or “virtualization aware”, i.e., the management virtual machine recognizes (may be able to determine and/or may be informed) that it is running in a virtual machine environment and may collaborate with the VMM to accomplish various management tasks such as querying information about the state of the Virtual Machines running on the host device. In one embodiment, the management virtual machine may operate as a Virtual Machine, with privileges not afforded to other Virtual Machines on the host device. In an alternate embodiment, the functionality of the management virtual machine may be integrated directly into the VMM, and/or an operating system capable of hosting the VMM, without departing from the spirit of embodiments of the present invention.

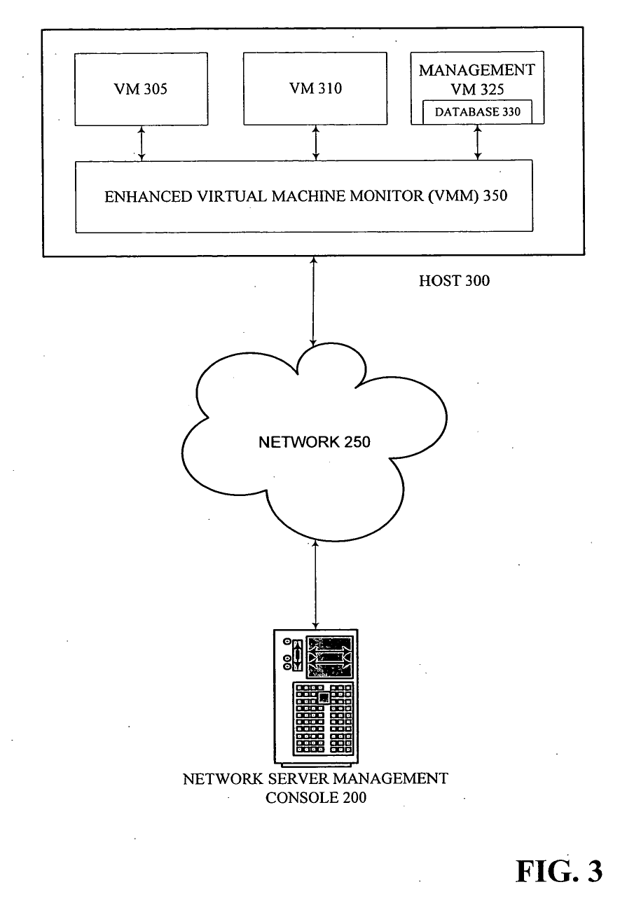

FIG. 3 illustrates an overview of an embodiment of the present invention. As illustrated, a host device (“Device 300”) may be coupled to a Remote Network Management Server 200 via Network 250. Device 300, in turn, may host multiple virtual machines managed by Enhanced VMM 350, i.e., a VMM adapted to implement embodiments of the present invention. Details of Enhanced VMM 350 are described in further detail below. In one embodiment of the present invention, VM 305 and VM 310 are typical virtual machines, while the third virtual machine on Device 300 (illustrated as “Management VM 325”) is designated the management virtual machine and may act as a proxy for the other virtual machines on the host. By allowing Management VM 325 to act as a proxy for VM 305 and VM 310, the number of purely-overhead context switches due to management messages may be reduced.

In one embodiment of the present invention, Management VM 325 may include a database (“Database 330’) that comprises information pertaining to all the virtual machines on Device 300. Thus, for example, Database 330 may include various types of network and system management information pertaining to VM 305 and VM 310 and Management VM 325 may periodically update the information in the database. Although Database 330 is illustrated in FIG. 3 as contained within Management VM 325, embodiments of the invention are not so limited. In alternate embodiments, Database 330 may reside in various other locations accessible by Management VM 325.

When Remote Management Console 200 issues a network management message to Device 300, the message may be intercepted by Management VM 325 and Management VM 325 may determine an appropriate action based on the message. Thus, for example, in one embodiment, if the information appropriate to respond to the query is available in Database 330, Management VM 325 may respond with this information on behalf of VM 305 and/or VM 310. If, on the other hand, the information is unavailable, Management VM 325 may retrieve the relevant information from the respective virtual machines. Enhanced VMM 350 and/or Management VM 325 may be configured in various ways according to other embodiments of the present invention. Thus, for example, Enhanced VMM 350 and/or Management VM 325 may pass on intercepted network management messages to one or more Virtual Machines. Alternatively, Management VM 325 may respond (or not respond) on behalf of the Virtual Machines, as described above. Additionally, the intercepted message to one or more Virtual Machines may be filtered, modified (e.g., including edited and/or reordered), and/or squashed (deleted) by Management VM 325.

The responses according to various embodiments may also differ. In one embodiment, Management VM 325 may provide a single, aggregate response, while in an alternate embodiment, multiple responses may be provided, if appropriate (e.g. one per Virtual Machine). Management VM 325 may also intercept outgoing messages from the Virtual Machines, and subsequently filter, modify, squash (delete), and/or aggregate the messages before sending them on. The latter may, for example, occur in response to an earlier message and/or may be messages originated by each of the Virtual Machines, such as a heart-beat (“I'm alive”) network message to Remote Network Management Server 200. It will be readily apparent to those of ordinary skill in the art that Management VM 325 may be configured in various other ways without departing from the spirit of embodiments of the present invention.

In one embodiment the Management VM 325 may partition Virtual Machines on Device 300 into various “classes” and respond to network management messages based on this information. Thus, for example, Management VM 325 may partition the virtual machines into classes based on the operating system (e.g. Windows 2000, Windows XP, Linux, etc) that each Virtual Machine is running. If so, according to this embodiment, the Management VM 325 may respond on behalf of one or more classes of virtual machines and/or on behalf of the physical machine. Other such classes or groupings may also be defined without departing from the spirit of embodiments of the present invention.

In one embodiment, the information may be provided directly to Remote Management Console 200. Alternatively, as previously described, Management VM 325 may aggregate the information prior to responding to Remote Management Console 200. Thus, for example, since the physical hardware for all the virtual machines on Device 300 is the same, messages related to the hardware (e.g., a query to report the CPU's temperature), may be handled by Management VM 325 without involvement from the other virtual machines. Remote Management Console 200 may therefore receive more accurate information about the state of the network than it would otherwise (i.e., instead of receiving a response from each virtual machine on the same physical host).

In one embodiment, Enhanced VMM 350 may include an interface and/or “hooks” that enable Management VM 325 to trap management messages bound for any of the virtual machines on Device 300 or Device 300 itself. More specifically, the interface enables Management VM 325 to snoop (i.e., monitor) and/or query Enhanced VMM 350 and/or take actions on behalf of each virtual machine on Device 300. Thus, for example, the interface may include the ability to intercept incoming network management messages to Device 300 and the ability to respond on behalf of Device 300 (e.g., via an interface into the operating system running on Device 300, to enable Management VM 325 to respond on behalf of Device 300). The concept of interfaces and/or “hooks” is well-known to those of ordinary skill in the art and further description thereof is omitted herein in order not to unnecessarily obscure embodiments of the present invention.

It will be readily apparent to those of ordinary skill in the art that the proxying functionality described herein may be implemented in a variety of ways without departing from the spirit of embodiments of the present invention. Thus, for example, although the above description assumes a single Management VM 325 on Device 300, in an alternate embodiment, Device 300 may include multiple management virtual machines and/or partitions that may act in conjunction to provide the proxying functionality described above. In yet another embodiment, the proxying functionality may be implemented in Enhanced VMM 350.

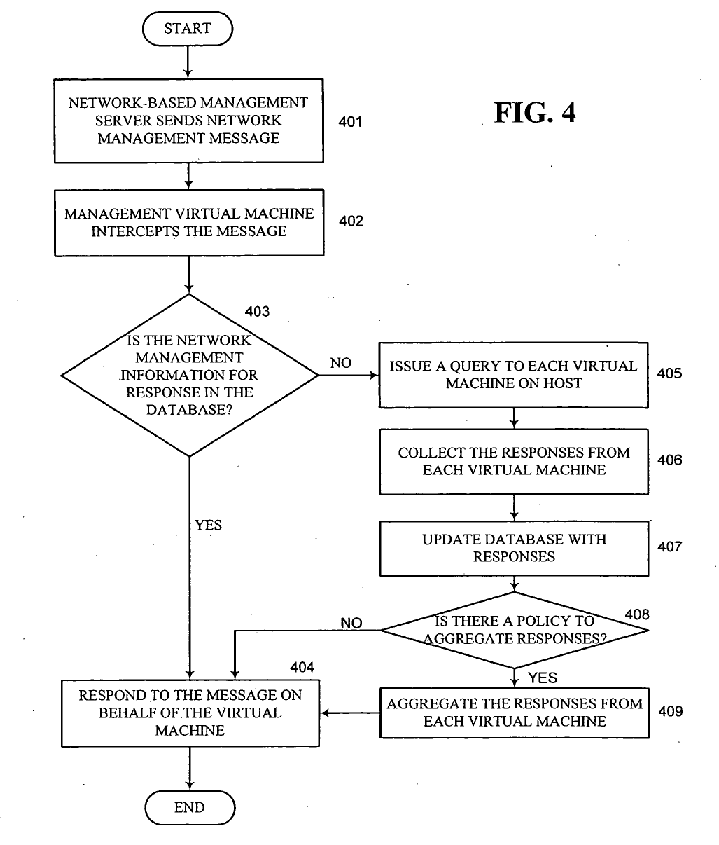

FIG. 4 is a flow chart of an embodiment of the present invention. Although the following operations may be described as a sequential process, many of the operations may in fact be performed in parallel and/or concurrently. In addition, the order of the operations may be re-arranged without departing from the spirit of embodiments of the invention. In 401, a network-based management server may send a management message to a host device hosting multiple virtual machines. In 402, the network management message may be intercepted by a management virtual machine on the host device. The management virtual machine may examine the message in 403 to determine if the information is available to the management virtual machine in its database (and that it is up to date i.e. coherent). If it is, the management virtual machine may take appropriate action in 404 on behalf of the virtual machine(s) on that host (e.g., respond, not respond, pass on the message to one or more of the virtual machines, etc.). If, however, the local database does not include the information and/or the information is outdated, the management virtual machine may issue a query in 405 to each virtual machine on the host. In one embodiment, only a subset of the virtual machines may be queried. In 406, the management virtual machine may collect the responses to the query and update the database with the collected responses in 407. The management virtual machine may then determine, based on its policies, whether to aggregate the collected information in 408. If the policy indicates the responses should be aggregated, the responses may be aggregated in 409 prior to responding appropriately in 404 to the network-based management server. If, however, the policy does not require aggregating the responses, the network management server may take appropriate action in 404 on behalf of the virtual machines.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of optimizing information provided on a network including virtual machine host devices, comprising:
intercepting a message from a network-based management server to at least one of the virtual machine host devices on the network;
accessing the information for at least one virtual machine running on the virtual machine host device; and
utilizing the information to respond to the message on behalf of the at least one virtual machine

2. The method according to claim 1 wherein accessing the information further comprises accessing the information from a database.

3. The method according to claim 1 wherein accessing the information further comprises issuing a request to the at least one virtual machine and utilizing a response from the at least one virtual machine to respond to the messages from the network-based management server.

4. The method according to claim 3 wherein utilizing the response from the at least one virtual machine further comprises at least one of filtering, modifying, deleting and reordering the response from the at least one virtual machine prior to responding to the messages from the network-based management server.

5. The method according to claim 3 wherein utilizing the response from the at least one virtual machine further comprises aggregating the response from the at least one virtual machine prior to responding to the message from the network-based management server.

6. The method according to claim 1 wherein accessing the information further comprises interfacing with a virtual machine manager to acquire the information.

7. The method according to claim 1 wherein the information is network-based management information including resource information pertaining to the virtual machine host devices.

8. The method according to claim 1 wherein the method further comprises grouping a plurality of virtual machines on the virtual machine host devices into at least one class of virtual machine, accessing the information for the at least one class of virtual machine running on the virtual machine host device and utilizing the information to respond to the message on behalf of the at least one class of virtual machine.

9. A system for optimizing information provided on a network including virtual machine host devices, comprising:
a virtual machine running on at least one of the virtual machine host devices; and
a management virtual machine capable of intercepting messages from a network-based management server to the virtual machine, the management virtual machine capable of accessing information pertaining to the virtual machine and utilizing the information to respond on behalf of the virtual machine.

10. The system according to claim 9 further comprising a virtual machine manager capable of obtaining the information pertaining to the virtual machine.

11. The system according to claim 9 wherein the virtual machine manager includes the management virtual machine.

12. The system according to claim 11 wherein the management virtual machine responds to the network management messages with one of information retrieved from a database and information obtained in response to queries to the virtual machine.

13. The system according to claim 12 wherein the management virtual machine at least one of filters, modifies, deletes and reorders the information obtained in response to the queries prior to responding to the network management messages.

14. The system according to claim 12 wherein the management virtual machine aggregates the information prior to responding to the messages from the network-based management servers.

15. The system according to claim 11 wherein the information is network-based management information including resource information pertaining to the virtual machine host devices.

16. The system according to claim 11 wherein the management virtual machine is further capable of grouping a plurality of virtual machines on the virtual machine host devices into at least one class of virtual machine, accessing the information for the at least one class of virtual machine running on the virtual machine host device and utilizing the information to respond to the message on behalf of the at least one class of virtual machine.

17. A method of optimizing information provided by a virtual machine host device, comprising:
grouping virtual machines on the virtual machine host device into at least one class;
intercepting a message from a network-based management server to the at least one class of virtual machines;
accessing the information for the at least one class of virtual machines; and
utilizing the information to respond to the message on behalf of the at least one class of virtual machine

18. The method according to claim 17 wherein the class includes one of a class based on operating system type and a class based on application type.

19. A system for optimizing information provided on a network including virtual machine host devices, comprising:
a class of virtual machines running on at least one of the virtual machine host devices, the class of virtual machines comprising a plurality of virtual machines; and
a management virtual machine capable of intercepting messages from a network-based management server to the class of virtual machines, the management virtual machine capable of accessing information pertaining to the class of virtual machines and utilizing the information to respond on behalf of the class of virtual machines.

20. The system according to claim 19 wherein the class of virtual machines includes at least one of a class of virtual machines based on operating system type and a class of virtual machines based on application type.

21. An management virtual machine residing on a virtual machine host device, comprising:
a module capable of intercepting messages to virtual machines residing on the virtual machine host device;
an interface capable of retrieving information pertaining to the virtual machines;
and
a module capable of utilizing the information to respond to the messages on behalf of the virtual machines.

22. The management virtual machine according to claim 21 wherein the information is network-based management information and includes resource information pertaining to the virtual machine host device.

23. The management virtual machine according to claim 21 wherein the interface is capable of retrieving the information from a virtual machine manager.

24. An article comprising a machine-accessible medium having stored thereon instructions that, when executed by a machine, cause the machine to:
intercept a message from a network-based management server to at least one virtual machine host devices on the network;
access the information for at least one virtual machine running on the virtual machine host device; and
utilize the information to respond to the message on behalf of the at least one virtual machine.

25. The article according to claim 24 wherein the instruction, when executed by the machine, are further capable of accessing the information from a database.

26. The article according to claim 24 wherein the instructions, when executed by the machine, further cause the machine to issue a request to the at least one virtual machine and utilize a response from the at least one virtual machine to respond to the messages from the network-based management server.

27. The article according to claim 26 wherein the instructions, when executed by the machine, further cause the machine to at least one of filter, modify, delete and reorder the response from the at least one virtual machine prior to responding to the messages from the network-based management server.

28. The article according to claim 26 wherein the instructions, when executed by the machine, further cause the machine to aggregate the response from the at least one virtual machine prior to responding to the message from the network-based management server.

29. The article according to claim 24 wherein the instructions, when executed by the machine, further cause the machine to interface with a virtual machine manager to acquire the information.

30. The article according to claim 24 wherein the instructions, when executed by the machine, further cause the machine to group a plurality of virtual machines on the virtual machine host devices into at least one class of virtual machine, access the information for the at least one class of virtual machine running on the virtual machine host device and utilize the information to respond to the message on behalf of the at least one class of virtual machine.
